(19) United States
(12) Patent Application Publication
(10) Pub. No.: US 2011/0094540 A1
(43) Pub. Date: Apr. 28, 2011

(54) STARCH PURGING MATERIAL

(75) Inventors: Peter A. Morken, Wilmington, DE (US); Karlheinz Hausmann, Auvernier (CH); Keith Christian Andersen, Hockessin, DE (US); Michael Joseph Molitor, Wilmington, DE (US); Mark D. Allen, Newark, DE (US); Thomas E. Lovelace, Port Deposit, MD (US)

(73) Assignee: E. I. DU PONT DE NEMOURS AND COMPANY, Wilmington, DE (US)

(21) Appl. No.: 12/899,761

(22) Filed: Oct. 7, 2010

Related U.S. Application Data
(60) Provisional application No. 61/254,951, filed on Oct. 26, 2009.

(51) Int. Cl. B08B 9/00; B29C 33/72

(52) U.S. Cl. 134/22.1; 264/39

(57) ABSTRACT

A method is provided for cleaning the interior of polymer processing equipment having a resin composition retained therein, wherein a contaminant material is adhered to at least a portion of the interior surface of the polymer processing equipment. The method comprises the steps of: charging the polymer processing equipment having a residual polymer composition retained in the interior thereof with a purging composition comprising 45-94 weight % of starch; 0.05 to 20 weight % of water; and (3) 5 to 45 weight % of polyol plasticizer, wherein the weight percentages of starch, water and polyol plasticizer are based on the total weight of starch, water and polyol plasticizer; operating the polymer processing equipment to i) convey the purging composition through the polymer processing equipment, thereby removing and withdrawing substantially all of the residual polymer composition from the polymer processing equipment and causing a portion of the purging composition to be retained as a residual purging composition within the interior of the polymer processing equipment; and ii) remove at least a portion of the contaminant material that is adhered to an interior surface of the polymer processing equipment; and removing the portion of the purging composition retained as a residual purging composition from within the interior of the polymer processing equipment.

### CROSS REFERENCE TO RELATED APPLICATION

This application claims the benefit of U.S. Provisional Application No. 61/254,951, filed Oct. 26, 2009, the entire contents being incorporated herein by reference.

### FIELD OF THE INVENTION

This invention relates to a method for cleaning the interior of polymer processing equipment comprising contacting the interior of the polymer processing equipment with a purging composition.

### BACKGROUND

The thermoplastic resin and elastomer industries process millions of tons of thermoplastic resins and elastomeric polymers per year. In many instances, these materials are processed in equipment such as injection molding machines and extruders that are subject to substantial wear as a result of the conditions of operation.

Injection molding machines and extruders operate at high temperatures and elevated pressures. Usually at some point in a polymer processing cycle the equipment is operated under high pressure, i.e. at least in excess of 15 psi, to convey the viscous polymeric material through the processing equipment. Depending upon the temperature and pressure conditions utilized and the viscoelastic properties of the particular polymer, thermoplastic and uncrosslinked elastomeric materials will either melt to form viscous liquids or soften to form putty-like solids or semi-solids during a processing cycle as the polymeric materials are forced with pressure through the processing equipment.

Extruders consist of a tube or barrel that contains an auger or screw device. The action of the auger or screw device conveys the polymeric material through the tube. During extrusion the extruder barrel is generally heated. Consequently, as the polymeric material is conveyed through the barrel, it is softened into a flowable mass. The softened polymeric material exits the barrel, either through an opening that is the shape of the final product (such as a slot die, annular die or profile) or into a mold. The heated, shaped polymeric material is allowed to cool and harden, thereby retaining its shape after exiting the die or mold.

When polymer molecules of a resin or uncrosslinked elastomer are subjected to elevated temperatures (e.g. 200-600° F.) and pressures (e.g. at least 15 psi and up to several tons per square inch) associated with extrusion and molding processes, there is some tendency for polymer degradation to occur. Although antioxidants and heat stabilizers may be added to the polymer compositions, small amounts of the polymers can degrade and residue particles may then plate out onto the surfaces of the feed lines and mold surfaces of injection molding machines, and onto the screw and barrel surfaces of extruders. Over time, the residue tends to gradually build up into a baked-on blackish-brown coating. The coating eventually increases in thickness to a point where it may begin to interfere with the process, causing defects such as deformation of parts or extrudates. The coating may also flake off into the hot polymer stream, forming defects in the finished shaped part, for example surface defects. When the coating thickness increases to an unacceptable level, product quality is impacted and the processing equipment must be cleaned.

Other instances that necessitate the cleaning of polymer processing equipment often occur when there is a transition between resins (including thermoplastic resins, thermoplastic elastomers, and uncrosslinked elastomers) in a processing operation. That is, when a new resin is introduced into the equipment following processing of a different resin during a production run. Specific instances include situations in which a color change is made to a resin or when a first-processed resin contains compounded ingredients and fillers that are incompatible or should not be intermixed with a second-processed resin. In either case, when transitioning between different resins in the processing equipment (e.g. an injection molding machine or extruder), a thorough cleaning or purging of the first resin is required before the next production run can begin. If a resin of different type or color is processed by a molding machine without removal of the residual prior resin retained therein, the resulting molded articles may have a poor appearance and/or poor properties due to the mixing of the residual resin into the molded article.

Even if the same resin is employed after the polymer processing equipment has been idled for a period of time without removing residual resin, the articles formed after the equipment is re-started may also have a poor appearance and/or poor properties due to incorporation into the new resin of residual resin which has been decomposed or denatured.

A number of methods have been employed to remove residual resin from plastic processing equipment. One method is to disassemble the equipment, (for example an injection molding machine or extruder), and physically remove the residual polymeric material from the metal parts, often with a power brush. Organic residues may also be removed by exposure to high temperature in an oven and/or sandblasting. The metal parts may also be submerged in a bath of hot caustic or other alkaline or basic agents, such as monoethanolamine, usually also containing surfactants, to break up polymeric residue build-up. Such processes may be suitable for operations in which many different resins are processed, or for equipment that incorporates screws that must be changed for processing of different resins. Disassembling the equipment is inconvenient and time-consuming when transitioning between resins in large-scale manufacturing operations. The time involved in disassembling, dip cleaning, and reassembling the equipment results in substantial loss of production time. Further, residual resin is likely to remain in some regions of the equipment, for example, on the inner wall of a cylinder or at points where disassembly of parts is difficult for a structural reason. In addition, there are serious safety considerations whenever equipment is cleaned with liquid solutions such as hot caustic baths.

When transitioning between resins, for example when color changes or compound changes are made, polymer processing equipment having residual first resin retained in the interior thereof can be cleaned or purged simply by charging the equipment with the second resin to be used for the subsequent operation and operating the equipment to pass the resin through the molding machine. The residual first resin is removed and withdrawn thereby. In this method, the processing equipment is operated, usually for multiple cycles, using resin that contains the new color additive or compound. The cycle is repeated with the new compound until parts are made or extrusion occurs free of the previous color or filler additives. The cleaning effect of the second resin may be so low that a large quantity of the resin is wasted, and a long period of time is consumed for cleaning. This is because such a resin may be suitable for molding, but not for cleaning. Consequently, generation of large amounts of scrap can occur. Generally, this scrap cannot be chopped or reground for re-use, and is landfilled, resulting in considerable waste. Further, some types of residues retained in polymer processing equipment, such as thermal decomposition products of elastomers, cannot be easily removed by this method.

A number of cleaning or purging compositions have been developed to facilitate cleaning polymer processing equipment. Cleaning compositions must be capable of effectively removing residual resin and elastomer from the interior of polymer processing equipment, yet be easily removable themselves when a new production resin is charged to the equipment.

Cleaning compositions are disclosed in U.S. Pat. Nos. 2,346,228; 5,139,694; 5,443,768; 5,427,623; 5,397,498; 5,395,456; 5,298,078; 5,238,608; 5,236,514; 5,124,383; 5,108,645; 5,087,653; and 4,838,945. Some cleaning agents include a foaming or blowing agent. Others of these cleaning compounds are solid thermoplastic resins that contain abrasive fillers (for example, glass or finely chopped fiberglass). For example, U.S. Pat. No. 5,298,078 teaches the melting of polystyrene and polyethylene and addition of alkaline salts and glass fibers as cleaning components. U.S. Pat. Nos. 5,124,383 and 5,139,694 teach the melting of polyethylene resin and then addition of abrasive inorganic fillers and polyethylene waxes and fatty acid amide waxes. U.S. Pat. No. 5,395,456 teaches the melting of polymers and inclusion of calcium carbonate abrasive and rosins as cleaning components.

Some cleaning compositions are intended to be mixed with the polymer stream entering the polymer processing equipment. U.S. Pat. No. 6,001,188 discloses a cleaning compound comprising a hard outer shell made from a thermoplastic resin and a soft inner core containing a substituted pyrrolidone. U.S. Pat. No. 6,384,002 teaches a cleaning composition comprising a blowing agent, abrasive, surfactant and binder.

The cleaning resins can be introduced to the polymer processing equipment in the same manner as compound resins for making production parts. The equipment is operated as if normal production is occurring, except that (a) the equipment is operated at a slower rate, and (b) the equipment is occasionally shut down. The slower rate of operation permits the abrasive fillers to attack hardened carbonized build-up.

Scheilbelhoffer (U.S. Pat. No. 5,443,768) and Obama (U.S. Pat. No. 5,108,645) both disclose the melting of polymers and the inclusion of hard methacrylate and acrylate compounds as cleaning media. Also, Ishida (U.S. Pat. No. 5,397,498) discloses the melting of a thermoplastic and inclusion of polyalkylene oxide based polyol cleaning agents.

U.S. Patent Application Publication 2003/0221707 describes a purging composition comprising a thermoplastic polymer and layered inorganic particles.

U.S. Pat. No. 5,958,313 describes a purging agent comprising (A) a hydrophobic thermoplastic resin, (B) a hydrophilic thermoplastic resin, and (C) a purging auxiliary selected from the group consisting of plasticizer, water and a crystal water-containing compound.

Mold cleaning compositions comprising mainly water soluble substances such as a mixture of wheat flour, ethylene glycol and calcium carbonate have been described in Japanese Patent Application Publication 58-193129. A mold cleaning agent comprising pyrrolidone, solvent, surfactant, rust preventing agent and/or tackifier such as potato starch has been described in Japanese Patent Application Publication 01-188311.

A number of biodegradable starch-containing materials have been developed recently as molding resins. Low density polyethylene (LDPE) has been recommended for purging starch-based materials at the end of production trials to prevent excessive degradation of thermally-sensitive starch.

A cleaning agent comprising starch, water, water-soluble thermoplastic resins, magnesium sulfate, sodium phosphate and/or water absorptive high polymers has been described for purging starch-containing molding resins in Japanese Patent Application Publication 08-244042.

It is also known to use small amounts of starch as compounding ingredients to reduce mold fouling during vulcanization, for example as disclosed in U.S. Pat. No. 6,096,248.

A major drawback to cleaning compounds of the prior art is that many of them adhere to the polymer processing equipment. In addition, some of the resins themselves tend to be abrasive in nature. For example, acrylate based resins that require high temperatures for melting can be very abrasive to the metal surfaces of the equipment. This extra wear on the surface can adversely affect the useful life of the equipment. Another disadvantage of some of these cleaning resins is that they contain monoethanolamine, which is a relatively toxic substance. During that portion of the cleaning cycle when the processing equipment is shut down, large quantities of amine compound vapors may be emitted from the hot processing machinery.

An improvement in the art of cleaning polymer processing equipment that involves use of a purging material that removes residual material from the polymer processing equipment but does not adhere to the equipment would be desirable.

### SUMMARY OF THE INVENTION

The invention is directed to a method for cleaning the interior of polymer processing equipment having a resin composition retained in the interior thereof, the resin composition comprising a polymer selected from the group consisting of thermoplastic resins, thermoplastic elastomers and uncrosslinked elastomers wherein the resin composition comprises less than 20 weight percent starch, and wherein a contaminant material is adhered to at least a portion of the interior of the polymer processing equipment, the method comprising the steps of:
(A) charging the polymer processing equipment having a resin composition retained in the interior thereof with a purging composition comprising
   (1) 45-94 weight % of starch;
   (2) 0.05 to 20 weight % of water; and
   (3) 5 to 45 weight % of polyol plasticizer,
   wherein the weight percentages of starch, water and polyol plasticizer are based on the total weight of starch, water, and polyol plasticizer;
(B) operating the polymer processing equipment to i) convey the purging composition through the polymer processing equipment, thereby removing and withdrawing substantially all of the resin composition from the polymer processing equipment and causing a portion of the purging composition to be retained as a residual purging composition within the interior of the polymer processing equipment; and ii) remove at least a portion of the contaminant material that is adhered to at least a portion of the interior of the polymer processing equipment; and
(C) removing the portion of the purging composition retained as a residual purging composition from within the interior of the polymer processing equipment.

The invention is further directed to a process for reducing defects in shaped resin articles that are formed in polymer processing equipment, the process comprising the steps of
A) charging a first resin to polymer processing equipment, the resin comprising a polymer selected from the group consisting of thermoplastic resins, thermoplastic elastomers and uncrosslinked elastomers wherein the resin comprises less than 20 weight percent starch and conveying said first resin through the polymer processing equipment to form a stream of the first resin such that a portion of said first resin is retained in the equipment;
B) forming one or more shaped articles comprising the first resin from the stream of the first resin;
C) cleaning the interior of the polymer processing equipment having a portion of said first resin retained therein by charging the polymer processing equipment with a purging composition, the purging composition comprising
   1) 45-94 weight percent starch;
   2) 0.05 to 20 weight percent water; and
   3) 5 to 45 weight percent polyol plasticizer;
   wherein the weight percentages of starch, water and polyol plasticizer are based on the total weight of starch, water and polyol plasticizer present in the purging composition;
D) operating the polymer processing equipment at a temperature below the decomposition temperature of the starch, to convey the purging composition through the polymer processing equipment, thereby removing and withdrawing substantially all of the first resin from the polymer processing equipment;
E) charging a second resin to the polymer processing equipment, the resin being different from the first resin and comprising a polymer selected from the group consisting of thermoplastic resins, thermoplastic elastomers and uncrosslinked elastomers wherein the resin comprises less than 20 weight percent starch and conveying said second resin through the equipment; and
F) forming one or more shaped articles of the second resin,
   whereby the one or more shaped articles of the second resin that are produced are substantially free of defects.

### DETAILED DESCRIPTION OF THE INVENTION

As used herein, the terms “purging composition,” and “cleaning composition” refer to a) compositions that are used to clean polymer processing equipment before or after the processing through such equipment of thermoplastic resins, thermoplastic elastomers or elastomers, or b) compositions that are used intermittently during processing of thermoplastic resins, thermoplastic elastomers or elastomers through such polymer processing equipment.

As used herein, the terms “resin”, “production resin,” and “molding resin” refer to compositions comprising polymeric materials that are used to form an article (including molded or shaped parts, films, pellets and sheets) or profile (such as tubing) and the like or to evaluate a process or material property. Resins include thermoplastic resins, thermoplastic elastomers and uncrosslinked elastomers (i.e. elastomeric materials that are not thermoset).

In one embodiment, the present invention is directed to a process for cleaning polymer processing equipment to remove contaminants, i.e. contaminant materials, that are adhered to the interior surface of polymer processing equipment. Interior surfaces include the interior walls of the processing equipment and the surfaces of mixing and conveying apparatus that are present within the polymer processing equipment. Contaminant materials include any material that is an unwanted component of the resin being processed. Contaminant materials include but are not limited to polymeric materials such as resin particulates, degradation products of a resin that has been processed through the equipment, crosslinked or gelled polymer, blackened, discolored or carbonized residues and lower molecular weight materials, such as additives or pigments that may have bled out of a resin composition that has been processed through the processing equipment, degradation products of additives, and residues of cleaning compositions.

In another embodiment, the present invention is directed to a process for reduction of defects during manufacture of resin articles in processes where transition from one resin to a second resin occurs as a part of a production run. Practice of the process of this particular embodiment increases the efficiency of production and uniformity of resin articles that are formed from the second resin during a production run. The resin articles produced as a result of the process have excellent integrity, surface smoothness, color, appearance and uniform physical properties because the first resin and/or contaminant materials are effectively removed from the processing equipment. The process provides an effective means for production of resin articles having a reduced level of defects, or that are substantially free of defects, especially surface defects. Defects include the presence of particles of degraded, discolored or highly crosslinked resin; voids or cracks in the surface or interior of the resin article; and discoloration of the surface of the finished article or the body of the formed article. The presence of contaminated material in a formed shaped article can also result in deterioration of physical and other end use properties, for example mechanical, impact, permeation and adhesion properties.

The process of the invention incorporates a cleaning step wherein a purge composition or cleaning composition that comprises starch is employed. During the cleaning step the purge composition is conveyed through the polymer processing equipment under conditions such that the temperature to which the purge composition is subjected is preferably below the decomposition temperature of the starch therein and wherein the throughput of the purge composition conveyed through the equipment during the cleaning step preferably remains constant within a range of plus or minus five percent. The maintenance of a relatively constant throughput is an indication that the purge composition is not being degraded and that particles of the purge composition, degradation products of the purge composition or other contaminants are not accumulating and adhering to the polymer processing equipment. Alternatively one may purge at temperatures up to 45° C. greater than the decomposition temperature if engineering controls are in place to capture volatile degradation products.

Generally, the ratio of elapsed time of processing resin in polymer processing equipment compared to the cleaning step wherein a purge composition is conveyed through the equipment is greater than 1, 2, 3, 5, 10, or 100.

Starch-containing compositions have been used to provide biodegradable resin compositions useful for manufacture of shaped articles such as rigid sheet, flexible film, or molded articles (see for example U.S. Pat. Nos. 5,043,196; 5,314,754; 5,322,866; 5,374,304 and 7,326,743 and PCT Patent Application Publication WO 08/014,573).

The present invention is directed to a method for purging or cleaning the interior of polymer processing equipment that has been used for processing thermoplastic resins, thermoplastic elastomers or elastomers under high temperature and high pressure conditions. By high temperature is meant 316° C. or 260° C. or 200° C. However, the process of the present invention is also useful for purging at lower temperatures, such as less than 200° C., or 150° C. or 100° C. By high pressure is meant at least 15 psi, and generally up to 40,000 psi. Processing equipment that may be cleaned using the process of the invention includes for example, injection molding machines, single screw extruders, twin screw extruders, blow molding machines, calenders, Buss kneaders and molding machines having a cylinder portion in which polymer compositions are heated and kneaded. The method is particularly suitable for use with extruders.

The invention provides a method for cleaning the interior of such polymer processing equipment that contains residual polymeric material selected from the group consisting of thermoplastic resins, thermoplastic elastomers and uncrosslinked elastomeric materials and which may also contain degradation products of these materials formed under the conditions of operation. The process of the invention is useful for removing residual polymeric material during transition between processing of two different resins. It is also useful for cleaning the interior of polymer processing equipment having contaminants adhered to the interior surfaces of the equipment and any mixing or conveying apparatus contained therein.

The method of the invention includes use of a purging composition that is charged to the polymer processing equipment, the purge composition comprising (a) 45-94 weight % of starch; (b) 1 to 20 weight % of water; and (c) 5 to 45 weight % of polyol plasticizer, where the weight percentages of the starch, water and polyol plasticizer are based on the total weight of starch, water and polyol plasticizer.

The first component of the purging composition is starch. As used herein, the term “starch” unless otherwise specified includes any of the various starches described below. Any starch, including those described below, is suitable for use as the first component of the purging composition.

Starch is a polysaccharide carbohydrate consisting of a large number of glucose units joined together by glycosidic bonds produced by essentially any green plant. Commercial sources of starch include but are not limited to cereal grains or root crops such as wheat, corn, rice, oat, arrowroot, pea and potato. Starch consists of two fractions: amylose, having a linear and helical molecular morphology, and amylopectin, having a branched morphology. Depending on the plant, naturally-occurring starch from plant sources generally contains 20 to 25% amylose and 75 to 80% amylopectin.

As described in greater detail in U.S. Pat. Nos. 5,043,196 and 5,314,754 various corn hybrids have been developed that provide starches of high amylose content and which have been available commercially since about 1963. As used herein “high amylose starch” refers to any starch with an amylose content of at least 45% and preferably at least 65% by weight. U.S. Pat. No. 5,374,304 discloses specialty amyloses obtained by treatment of high amylose starches with formamide solution with a small proportion of dichloroacetic acid. Additionally, high amylose starch can be obtained by separation or isolation such as by the fractionation of a native starch material or by blending isolated amylose with a native starch.

Starch can also be derivatized or modified by typical processes known in the art, e.g., esterification, etherification, oxidation, acid hydrolysis, crosslinking and enzyme conversion. Modified starches include esters, such as the acetate and the half-esters of dicarboxylic acids, particularly the alkenylsuccinic acids; ethers, such as the hydroxyethyl- and hydroxypropyl starches and starches reacted with hydrophobic cationic epoxides; starches oxidized with hypochlorite; starches reacted with cross-linking agents such as phosphorus oxychloride, epichlorohydrin, and phosphate derivatives prepared by reaction with sodium or potassium orthophosphate or tripolyphosphate and combinations thereof. Anhydrides such as maleic, phthalic, or octenyl succinic anhydride can also be used to produce ester derivatives. These and other conventional modifications of starch are described in publications such as “Starch: Chemistry and Technology”, Second Edition, edited by Roy L. Whistler et al. Chapter X; Starch Derivatives: Production and Uses by M. W. Rutenberg et al., Academic Press, Inc., 1984. These processes can be used to modify any starch, notably including high amylose starches.

One modification of note is etherification with alkylene oxides, particularly those containing 2 to 6, preferably 2 to 4, carbon atoms. Ethylene oxide, propylene oxide and butylene oxide are exemplary compounds useful in etherifying the starting starch materials. Propylene oxide is preferred, providing “hydroxypropylated” starches. Other substituents can be hydroxyethyl or hydroxybutyl to form hydroxyether substitutions. U.S. Pat. Nos. 5,043,196; 5,314,754 and 7,326,743 describe various modified high amylose starches.

The degree of substitution (the average number of hydroxyl groups in a unit that are substituted) for any of these modifications may be 0.05 to 2.

Mixtures of unmodified or modified starch can be used as the starch component of purging composition. Any mixture may be used, such as from 5 to 95 weight % of modified starch in the starch component. The upper limit to the content of the modified starch may be determined largely by its cost. Hydroxypropylated amylose is a useful modified starch. Notable starches include high amylose maize starch, and hydroxypropylated high amylose starch.

Unmodified starches and starches other than hydroxypropylated high amylose starch are also useful in the practice of the invention.

Another starch that may be used as the first component of the purge compositions is ReNew 400 resin available from StarchTech, Inc, Golden Valley, Minn. and is comprised of starch and optionally biodegradable polymers. The starch used is an unmodified industrial grade starch, typically wheat, corn, and/or potato. ReNew 400 resin is certified to meet EN 13432, which means that a biodegradation level of at least 90% is reached in less than 6 months under controlled composting conditions. While the composition of ReNew 400 is a trade secret, it is known from U.S. Pat. No. 5,095,054 that biodegradable loose-fill resins have improved properties when they contain a substantially water-insoluble thermoplastic polymer. Extraction of ReNew 400 with toluene solvent yielded about 2 weight % on a dry basis of substantially water-insoluble thermoplastic polymer(s).

The amount of starch present in the purge composition ranges from 45 to 94 weight percent, preferably from 45 to 80 weight percent, based on the total weight of starch, water, and polyol plasticizer in the purge composition. The amount of starch depends on the particular conditions of use. For example, for processes that require low viscosity purge compositions, then lower quantities of starch and/or starch with lower molecular weight can be utilized. For processes where a very high viscosity purge composition is required, larger quantities of starch and/or starch with higher molecular weight are desirably used.

Water is a second component of the purging composition. Water “gelatinizes” (a process also known as destructuring or melting) the starch to form a polymeric gel structure. In order to provide appropriate starch gelatinization, high water levels are used. Once gelatinized, excess water can be removed from the purging composition useful in practice of the invention by drying the composition to reach relatively low water levels before the composition is further processed. Water may also act as a plasticizer in that it softens the material or reduces the modulus. The rheology of the purge composition is strongly influenced by the presence of water. High water content of the purge composition, such as 20 wt %, results in relatively low viscosity. A low water content, such as 0.5 wt % water, results in much higher viscosity of the purge composition. It is advantageous to tailor the water content to provide the maximum viscosity material that the polymer processing equipment can convey at the selected purging temperature so as to provide the most effective scrubbing or cleaning action. On the other hand, water can be beneficial for aiding in cleaning by steam evolution, foaming, or hydrolytic degradation of the residual resin.

It is desirable that the total moisture content of the starch-containing purging composition be at a level of 20% or less by weight, based on the dry weight of starch material. By total moisture or water content is meant both the residual moisture of the starch, that is the amount absorbed while stored at ambient conditions, and the amount of water fed to the polymer processing equipment, e.g. an extruder. Typically, starch and particularly high amylose starch may contain about 9 to 12% residual moisture before drying. “Pre-gelatinized” starch may have about 6 weight % water or less after drying. Enough water must be present to allow the material to be processed, mixed and heated to the desired temperatures. While some water may be added to the extruder, only an amount which will bring the total moisture level to 20% or less can be added. Accordingly, while the total moisture content that is used for carrying out the process of the invention may vary somewhat, depending on the actual material used and other process variations, a range of from about 0.05 to 20%, preferably from about 1 to 15% and more preferably from about 1 to 10% by weight, will generally be suitable.

The third component of the purging composition is a polyol plasticizer. Suitable plasticizers include organic compounds containing more than one hydroxyl group per molecule or derivatives thereof. Derivatives of the polyols include esters such as acetates. Preferred polyol plasticizers have a molecular weight in the range of 50-6000, more preferably 50-2500, and still more preferably 100-400. They are preferably selected from the group consisting of sorbitol, glycerol (also known as glycerin), maltitol, xylitol, mannitol, erythritol, di- or polyglycerol, glycerol mono- and diesters of fatty acids, glycerol acetates such as glycerol mono- or diacetate, polyethylene oxide, ethylene glycol, diethylene glycol or polyethylene glycol, trimethylolpropane, pentaerythritol; more preferably glycerol, maltitol, sorbitol, erythritol and/or xylitol. Other plasticizers which may be used include invert sugar and corn syrup.

The polyol plasticizers have a range of molecular sizes and weights that allow for different degrees of association with starch. Higher molecular weight plasticizers such as maltitol increase the modulus of the composition, while low molecular weight plasticizers such as glycerol are very volatile and may be lost during drying or processing of the composition. Mixtures of plasticizers may be desirable since a high level of a single plasticizer may result in incomplete mixing with the starch. Particularly useful mixtures of plasticizers include a mixture of at least two plasticizers selected from the group consisting of glycerol, maltitol, sorbitol, erythritol and xylitol, such as a mixture of sorbitol, maltitol and glycerol, and a mixture of sorbitol, xylitol and glycerol.

A minimum level of plasticizer (water and/or polyol) may be desirable in order to properly process the purging composition to provide effective cleaning of the polymer processing equipment. At low water content (such as less than 10 weight percent, or less than 5 weight %), the plasticizer content may be 5 to 45 weight %, preferably 15 to 35 weight %.

U.S. Pat. No. 5,374,304 discloses compositions of specialty high amylose starch and a glycerol plasticizer. U.S. Pat. Nos. 5,314,754 and 7,326,743 describe various modified high amylase starches in compositions with water and polyol plasticizers such as glycerol.

The purging composition useful in the practice of the invention may optionally comprise up to 20 parts by weight per 100 parts purging composition of a substantially water-insoluble thermoplastic resin. Preferably the amount of substantially water-insoluble thermoplastic resin will be no more than 2 parts by weight per 100 parts purging composition. By substantially-insoluble thermoplastic resin is meant that the resin when immersed in water at 25° C. has less than 10% soluble fraction. Examples of such resins include polyolefins such as polyethylene, ethylene copolymers with other alkenes, polypropylene, ethylene copolymers comprising a polar comonomer, homopolymers and copolymers of styrene, polyesters, polyamides and polyurethanes.

Ethylene copolymers comprising a polar comonomer include polymers comprising copolymerized units of ethylene and at least one polar comonomer selected from the group consisting of vinyl acetate, alkyl acrylate, alkyl methacrylate, acrylic acid, methacrylic acid, cyclic anhydrides of C₄-C₈ unsaturated acids, C₄-C₈ unsaturated acids having at least two carboxylic acid groups, monoesters of C₄-C₈ unsaturated acids having at least two carboxylic acid groups and diesters of C₄-C₈ unsaturated acids having at least two carboxylic acid groups, and carbon monoxide. The copolymerized units result from copolymerization of the monomers, generally free radical-initiated random copolymerization. Thus, the copolymer backbone is formed of copolymerized monomer units of ethylene and the polar comonomer. Ethylene copolymers comprising a polar comonomer also include ionomers of copolymers of ethylene and acrylic acid, methacrylic acid or other unsaturated acid-containing comonomers, optionally containing other polar comonomers such as alkyl acrylate and alkyl methacrylate, wherein at least a portion of the acid moieties in the copolymer are neutralized to salts of alkali metals, alkaline earth metals and/or transition metals.

Preferred resins include ethylene copolymers including ethylene/alkyl acrylate copolymers, ethylene/alkyl methacrylate copolymers, ethylene/acrylic acid copolymers, ethylene/methacrylic acid copolymers, ethylene/vinyl alcohol copolymer with greater than 20 mol % ethylene, and homo- and copolymers of styrene.

The purging composition may further optionally comprise from 2 to 15 parts by weight per 100 parts by weight of purging composition of a water soluble polymer, preferably one that is compatible with starch, water soluble, and biodegradable. Desirably, the water soluble polymer has a low melting point or dissolution temperature that is compatible with the processing temperatures and water levels for starch. Desirably the melting point of the water soluble polymer will be at least equivalent to the temperature at which the combination of starch, water, polyol plasticizer and substantially-insoluble thermoplastic resin exists in a molten state of the starch components. Alternatively, a preferred water soluble polymer will dissolve completely in the purge composition at the particular polymer processing temperature at which it is to be used. The water soluble polymer is preferably selected from the group consisting of polyvinyl alcohol (PVOH), partially hydrolyzed polyvinyl acetate and copolymers of ethylene and vinyl alcohol (EVOH) with less than 20 mol % ethylene content. Polyvinyl alcohol is a preferred polymer, but polymers of ethylene vinyl alcohol or blends with polyvinyl alcohol may also be used.

PVOH is manufactured commercially by polymerization of vinyl acetate monomer (VAM) to afford polyvinyl acetate (PVAc). The PVAc is then transesterified (loosely referred in the industry as “hydrolysis”) to provide PVOH. In most commercial processes the transesterification is carried out with methanol to afford PVOH and methyl acetate. Fully hydrolyzed grades (>98% hydrolyzed, or less than 2% residual acetate groups) require temperatures in excess of 50° C. to dissolve in water but remain in solution on cooling. Partial hydrolysis can be conveniently and conventionally accomplished by carrying out the transesterification of PVAc in such a manner as to not complete the conversion to PVOH and obtain a product that is conventionally known as partially hydrolyzed PVOH (phPVOH). The degree of conversion in most cases varies from 78-99.8%, and 88% hydrolyzed is an especially common grade. Preferred grades of PVOH include those having weight average molecular weight from 10,000 to 200,000 Daltons, preferably 20,000 to 120,00 Daltons. Suitable PVOH polymers may be obtained from DuPont under the ELVANOL tradename and include ELVANOL 90-50, ELVANOL 71-30, and ELVANOL 70-62. Commercial grades of phPVOH include CELVOL 523 from Celanese Chemicals and Kuraray POVAL PVA 217 sold by Kuraray Co., Ltd.

EVOH polymers generally have an ethylene content of between about 15 mole percent to about 60 mole percent, more preferably between about 20 to about 50 mole percent. The density of commercially available EVOH generally ranges from between about 1.12 g/cm³ to about 1.20 gm/cm³, the polymers having a melting temperature ranging from between about 142° C. and 191° C. EVOH polymers can be prepared by well-known techniques or can be obtained from commercial sources. EVOH copolymers may be prepared by saponifying or hydrolyzing ethylene vinyl acetate copolymers. Thus EVOH may also be known as hydrolyzed ethylene vinyl acetate (HEVA) copolymer. The degree of hydrolysis is preferably from about 50 to 100 mole percent, more preferably from about 85 to 100 mole percent. In addition, the weight average molecular weight, M_{w}, of the EVOH component useful in the purging compositions of the invention, calculated from the degree of polymerization and the molecular weight of the repeating unit, may be within the range of about 5,000 Daltons to about 300,000 Daltons with about 60,000 Daltons being most preferred. Suitable EVOH polymers may be obtained from Eval Company of America or Kuraray Company of Japan under the tradename EVAL such as EVAL F101, EVAL E105, EVAL J102. EVOH is also available under the tradename SOARNOL from Noltex L.L.C. such as SOARNOL DT2903, SOARNOL DC3203 and SOARNOL ET3803.

The purging composition may also optionally include from 2 to 50 parts by weight of filler per 100 parts by weight of purging composition. Fillers often aid in removing baked-on polymer residues from the metal parts of the polymer processing equipment. Natural fibers or minerals are preferred as fillers. A key consideration in selecting a filler is the aspect (length to width) ratio of the filler. High aspect ratio fillers such as wood flour and wollastonite (calcium metasilicate) provide higher stiffness. Other natural minerals useful as fillers include aluminum silicate and sodium-potassium-aluminum silicate. Natural fibers (sisal, jute, animal hair, oatmeal, etc,) also provide higher stiffness and may also improve water resistance. Chitin is a natural polysaccharide with D-glucosamine as its repeat unit, produced by a range of invertebrate animals including shrimp, crabs and squid. Chitosan is a modified form of chitin that is more easily handled and processed. Other fillers include silica and silica-based by-products of food processing (e.g. rice husks). Inert fillers such as talc or mica can lead to softer compositions with improved toughness. Other suitable fillers include calcium carbonate, kaolin, clay, titanium dioxide, and polymorphs of silicon dioxide.

A second consideration in selecting a filler is its hardness. Soft fillers such as talc, mica and calcium carbonate have Mohs hardness of about 1 to 2. They may be too soft to provide effective scouring of metal parts. Hard fillers may result in significant abrasion of the metal parts, potentially limiting the service lifetime of the polymer processing equipment. Fillers with Mohs hardness from 3 to 7 may be preferred, providing good scouring without unduly abrading the metal parts of the equipment. Calcium metasilicate, aluminum silicate and sodium-potassium-aluminum silicate have Mohs hardness of about 4.5 to 6. Crystalline quartz Mohs hardness is about 6-7.

Because fillers provide scouring of the metal parts of the polymer processing equipment, it may be desirable to limit use of the purging composition containing fillers so as to minimize excessive wear on the metal parts. Accordingly, the purging composition without fillers preferably may be used for transitional purging between two different resins, while purging compositions with fillers preferably may be used for more extensive cleaning, such as for removal of baked-on polymer residues or cleaning of equipment when changing extruder screws, molds and the like.

The compositions may further comprise small amounts of optional materials commonly used and well known in the polymer art, such as disclosed in WO2008/014573. Such materials include lubricants, emulsifiers and antioxidants.

Lubricants include one or more fatty acids and fatty acid salts. The fatty acids include saturated (preferably saturated) or unsaturated monobasic carboxylic acids. Monobasic carboxylic acids include acids having only one carboxylic acid moiety. Particularly useful fatty acids include C₄ to less than C₃₆ (e.g., C₃₄), more particularly C₆ to C₂₆, and even more particularly C₆-C₂₂ acids. Specific organic acids include, but are not limited to, lauric acid, myristic acid, palmitic acid, stearic acid, behenic acid, erucic acid, oleic acid, and linoleic acid. Saturated acids are preferred. Salts of the fatty acids include sodium, potassium and calcium salts such as calcium stearate, sodium stearate and potassium stearate. The amount of fatty acid and/or fatty acid salt may be from 0.1-5.0 parts, preferably 0.2 to 3 parts per hundred parts of the purging composition (i.e. starch, water and polyol plasticizer). Other lubricants include amides of fatty acids such as erucamide.

Emulsifiers include those wherein the hydrophilic lipophilic balance (HLB) is between 1 and 22. Emulsifiers include propylene glycol monostearate, glycerol monooleate, glycerol monostearate, acetylated monoglycerides (stearate), sorbitan monooleate, propylene glycol monolaurate, sorbitan monostearate, calcium stearoxyl-2-lactylate, glycerol monolaurate, sorbitan monopalmitate, soy lecithin, diacetylated tartaric acid esters of monoglycerides, sodium stearoyl lactylate, and sorbitan monolaurate. Emulsifiers may be present at a level of from 0.2 to 3 parts per hundred parts of the purging composition and act to stabilize mechanical properties and increase homogeneity of the blend. They may also provide a defoaming effects and antiretrodegradation effects. Glycerol monostearate (for example at 1 to 1.5 parts per hundred parts purging composition) and sodium stearoyl lactylate (for example at 0.25 to 1.5 parts per hundred parts purging composition) and combinations thereof are notable.

Primary and secondary antioxidants include butylated phenol derivatives such as for example IRGANOX 1010, phosphites such as IRGAFOS 168, sulfating agents such as sulfur dioxide, sodium sulfite, sodium and potassium bisulfites and metabisulfites, citric acid, optionally combined with ascorbic acid or sodium bisulfite and tocopherol. Antioxidants may be included at up to about 2 parts per hundred parts purging composition.

Other additives include stabilizers including viscosity stabilizers, heat stabilizers, and hydrolytic stabilizers, ultraviolet ray absorbers and stabilizers, anti-static agents, fire-retardants, and/or mixtures thereof. Many such additives are described in the Kirk Othmer Encyclopedia of Chemical Technology, 5^{th} edition, John Wiley & Sons (Hoboken, 2005). These conventional ingredients may be present in the compositions in quantities that are generally from 0.01 to 5 parts per hundred parts purging composition, so long as they do not detract from the basic and novel characteristics of the composition and do not significantly adversely affect the performance of the material prepared from the composition.

PCT International Patent Application Publication WO2008/014573 describes a biodegradable injection moldable polymer composition that is suitable for use in the process of the invention. The composition includes on a dry weight basis from 45-85% w/w by weight of a starch and/or a modified high amylose starch, from 2-15% w/w by weight of a water soluble polymer preferably selected from polyvinyl alcohol, polyvinyl acetate and copolymers of ethylene and vinyl alcohol which have a melting point compatible with the molten state of the starch components, and from 5-45% w/w by weight of one or more polyol plasticizers having a molecular weight in the range of 50-6000, more preferably 50-2500, and still more preferably 100-400 and preferably selected from the group consisting of sorbitol, glycerol, maltitol, xylitol, mannitol, erythritol, polyglycerol, glycerol trioleate, tributyl citrate, acetyl tri-ethyl citrate, glyceryl triacetate, 2,2,4-trimethyl-1,3-pentanediol diisobutyrate, polyethylene oxide, ethylene glycol, diethylene glycol or polyethylene glycol; more preferably glycerol, maltitol, sorbitol, erythritol and xylitol. The composition is preferably substantially soluble in water.

The three-component purging compositions described herein, including such compositions that contain optional additives, have been found to be remarkably less adherent to a metal (for example, a metal constituting the interior, such as a cylinder portion, of a polymer processing machine) compared to other thermoplastic compositions. In addition, such compositions have been found to effectively remove adhered contaminants such as residual resin compositions, from the surfaces of the interior of the polymer processing machine, without sticking to the same, thereby exhibiting an excellent cleaning effect. These properties make such compositions very useful as purging compositions.

Thus, the purging composition described herein is used to clean polymer processing equipment, such as extruders and molding machines and internal mixers that have residual thermoplastic resin compositions, thermoplastic elastomer compositions and uncrosslinked elastomer compositions retained therein. The purge composition is useful for removing both polymer residue as well as contaminants such as degradation products produced during processing of the polymeric material. For example, the composition is useful in removing polymers selected from the group consisting of polyethylenes, including polyethylene homopolymers and copolymers, polypropylenes, ethylene copolymers comprising a polar comonomer as described herein, polyesters, copolyesters, copolyesterethers, copolyetheramides, polyvinyl chloride, poly(hydroxyalkanoic acids), polyoxymethylene, polyamides, polycarbonates, polystyrene, polyurethanes, urethanes, and cellulose and ether and ester derivatives thereof, such as hydroxypropyl cellulose, cellulose triacetate, cellulose acetate butyrate (CAB), and cellulose acetate propionate. Grafted polymers of these polymers, for example modified with maleic anhydride as a grafting agent, may also be removed from polymer processing equipment using the purge composition and methods described herein. The composition is also useful in removing additives commonly used in the polymer industry such as pigments, colorants, fillers, flame retardants, etc.

The process of the invention involves the use of the above-described purge composition. In the practice of the method of the invention, the polymer processing equipment having residual resin compositions therein is (1) charged with the purging composition; (2) the polymer processing equipment is operated to convey the purging composition through the polymer processing equipment, thereby removing and withdrawing substantially all of the residual polymer composition from the polymer processing equipment and causing a portion of the purging composition to be retained as a residual purging composition within the interior of the polymer processing equipment and removing at least a portion of the contaminant material (generally substantially all contaminant material) that is adhered to the interior surfaces of the polymer processing equipment; and (3) the portion of the purging composition retained as a residual purging composition is removed from within the interior of the polymer processing equipment. By substantially all is meant at least 55%, or at least 65%, preferably at least 80%, more preferably at least 90% and most preferably at least 95% of the adhered contaminant material that is removed from the interior surfaces of the equipment, where interior surfaces includes any mixing or conveying apparatus within the interior of the polymer processing equipment.

The portion of the purging composition retained as a residual purging composition may be removed from within the interior of the polymer processing equipment by disassembling the polymer processing equipment and physically cleaning the interior of the polymer processing equipment. This method is particularly useful when disassembly of the processing equipment is needed for a purpose in addition to cleaning the equipment, such as exchanging a screw in an extruder or changing molds in a molding machine.

Alternatively, the portion of the purging composition retained as a residual purging composition may be removed from within the interior of the polymer processing equipment by charging the polymer processing equipment, while it has a portion of the purging composition retained therein, with a fresh polymer composition selected from the group consisting of thermoplastic resin compositions, thermoplastic elastomer compositions and uncrosslinked elastomer compositions; and operating the polymer processing equipment to convey the fresh polymer composition through the polymer processing equipment, thereby removing and withdrawing substantially all of the purging composition from the polymer processing equipment. This alternative is particularly useful for transitional purges in order to change one resin composition for another without shutting down the polymer processing equipment.

The amount of the cleaning composition to be charged into the processing equipment depends mainly on the purpose (for example, color change, resin change, or residue removal), the type of the polymer residue or degradation product present in the equipment (e.g. residual molding resin) retained in the interior of the molding machine and the capacity of the equipment (such as maximum injection shot weight of the molding machine). The optimum amount of the cleaning composition can be determined by preliminary trials with the individual equipment. Generally the ratio of purge composition to polymer will be from one to one hundred, preferably from 1-20 times that of the residual resin retained in the interior of the polymer processing equipment to be cleaned.

Charging of the purge composition to the polymer processing equipment may be continuous or a discrete amount of purging composition may be added to the equipment.

The processing equipment may be operated with the purging composition therein for about 5 minutes to about 60 minutes to allow for scrubbing the parts of the equipment. Cleaning times of five to ten minutes may be used to purge many resins. For especially odorous systems such as cellulose acetate butyrate or for tenaciously adhered contaminant materials, purge times of about one hour may be desirable. However, the amount of time for purging may be even longer and is dependent on the particular resin or contaminant to be purged.

The purging temperature depends on the thermal stability of the purging composition and the local ventilation. Desirably, the temperature should be high enough to remove resin before it freezes and hardens in the equipment. Lower temperatures are advantageous because the viscosity of the purging composition is higher at lower temperatures, which assists the cleaning mechanism. Purging temperatures of about 130° C. to 250° C. may be suitable. The term “high temperature flow resin” as used herein, refers to a resin that must attain a temperature of between 500-600° F. (260°-316° C.) before becoming capable of flow into a mold or through an extruder die. Such resins include polycarbonate, some polyesters, and nylon resins. If the freezing point of the resin to be purged is too high (a high temperature flow resin) to directly use the purging composition described herein to purge due to insufficient thermal stability, then an intermediate purge strategy can be implemented by purging with a polymer having an intermediate processing temperature followed by the purging composition. For example, purging polyethylene terephthalate (extruder barrel 280° C.) may be accomplished by first purging with a small amount of high density polyethylene, then lowering the temperature of the barrels to 200° C., and finally purging with the purging composition useful in the practice of this invention.

Purging pressure also depends on the equipment to be purged and the resin to be purged and may range from about 15 to 40,000 psi.

In one embodiment of the method of the invention, the residual purging composition retained in the polymer processing equipment is replaced with the fresh resin in accordance with the operation of the machine, and removed and withdrawn to the outside of the equipment. Simultaneously with the removal and withdrawal of the residual purging composition, the machine is charged with the fresh resin. In another embodiment of the method, however, replacing the residual purging composition with and loading the machine with the fresh resin is a final step for cleaning the machine until the replacement and withdrawal of the residual purging composition are completed.

The invention is illustrated by the following embodiments.

### EXAMPLES

### Materials

TPS-1-Biomax® TPS 2100—density 1.434 g/cm³, DMA T_{g} −5° C., Vicat Softening Point 55° C., a mixture of 35-70 wt. % modified starch, 30-65 wt. % process aids and modifiers, less than 15 wt. % glycerin, less than 0.5 wt. % methanol and less than 0.6 wt. % sodium acetate, available from DuPont.
TPS-2-Biomax® TPS 2301—density 1.414 g/cm³, DMA T_{g} −10° C., Vicat Softening Point 45° C., a mixture of 35-70 wt. % modified starch, 30-65 wt. % process aids and modifiers, less than 15 wt. % glycerin, less than 0.5 wt. % methanol and less than 0.6 wt. % sodium acetate, available from DuPont.
TPS-3-Biomax® TPS 2501—density 1.492 g/cm³, DMA T_{g} −3° C., Vicat Softening Point 70° C., a mixture of less than 50 wt. % modified starch, less than 20 wt. % process aids and modifiers, less than 10 weight % quartz, less than 5 wt. % glycerin and less than 20 wt. % non-regulated fillers, available from DuPont.
IS-1-ReNEW 400 pellets—commercially available industrial starch, available from StarchTech, Inc, Golden Valley, Minn.
Ionomer-1—ethylene/methacrylic acid/iso-butyl acrylate ionomer (10 weight % methacrylic acid copolymerized units, 10 weight copolymerized iso-butyl acrylate units) in which the methacrylic acid groups have been partially neutralized with zinc ions, melt flow rate (190° C./2.16 kg) 1 g/10 minutes, melting point (DSC) 85° C.
Ionomer-2—ethylene/methacrylic acid copolymer ionomer (19 weight % copolymerized methacrylic acid units) in which the methacrylic acid groups have been partially neutralized with zinc ions, melt flow rate (190° C./2.16 kg) 1.3 g/10 minutes, melting point (DSC) 86° C.
EMA-1—copolymer of ethylene and methyl acrylate (35 wt. % copolymerized methyl acrylate units), melting point (DSC) 78° C., melt flow rate (190° C./2.16 kg) 3 g/10 minutes.
EMA-2—copolymer of ethylene and methyl acrylate (62 wt. % copolymerized methyl acrylate units), melt flow rate (109° C./2.16 kg) 15 g/10 minutes, available from DuPont.
EMAA-1—copolymer of ethylene and 11 wt. % methacrylic acid, melting point (DSC) 94° C., melt flow rate (190° C./2.16 kg) 95 g/10 minutes.
EVA-1—copolymer of ethylene and vinyl acetate (18 wt. % vinyl acetate) melt flow rate (190° C./2.16 kg) 2.5 g/10 minutes.
LDPE-1—low density polyethylene, melt index (190° C./2.16 kg) 4.5 g/10 minutes, density 0.923 g/cm³.
HDPE-1—high density polyethylene, melt index (190° C./2.16 kg) 12.5 g/10 minutes, peak melting point (DSC) 137.5° C.
HDPE-2—medium molecular weight high density polyethylene homopolymer, density 0.960 g/cm³, melt index (190° C./2.16 kg) 6.0 g/10 minutes, available as ALATHON® M6060 from Lyondell Chemical Company, Houston, Tex.
PA-6—polyamide 6 (Nylon-6), melting point (DSC) 220° C., available as Ultramid® B27 E 01 from BASF, Freeport, Tex.
PET-1—polyethylene terephthalate, intrinsic viscosity 0.83 dL/g.
CAB-531-1—Cellulose acetate butyrate, 50 wt % butyryl, 2.8 wt % acetyl, and 1.7 wt % hydroxyl content, T_{g} 115° C., melting range 135-150° C. available from Eastman Chemical Co., Kingsport, Tenn.
POM-1—polyoxymethylene resin, melting point (DSC) 178° C. Thermoplastic Elastomers (TPE)—polyetherester polymers, available under the tradename Hytrel® polyetherester elastomer from DuPont.
PP-1—polypropylene random copolymer, density 0.900 g/cc, melt flow rate (190° C./2.16 kg) 1.50 g/10 minutes, melting point 143° C., available as Total Petrochemicals Type 7253× from Total Petrochemicals USA, Inc., Houston, Tex.
S-1—native common corn starch, available as Cargill Native Gell 03420 from Cargill, Inc., Cedar Rapids, Iowa.
S-2—hydrolyzed potato starch, available as Penbind 800 starch from Penford Food Ingredients, Centennial, Colo.
BMB-1—black masterbatch, 30:70 weight ratio blend of carbon black and a copolymer of ethylene and 20 wt. % methyl acrylate, melt flow rate (190° C./2.16 kg) 8 g/10 minutes.
PC-1—commercial purging composition containing a high viscosity, low density polyethylene resin and various additives to assist in purging and cleaning the extruder, melting point (DSC) 109° C. and melt flow rate (190° C./2.16 kg) 0.5 to 1.5 g/10 minutes, obtained from DuPont.
PC-2—commercial purging composition containing cast polymethyl methacrylate, available as Super-Scrub® Bamberko Purge Type 9016C from Claude Bamberger Molding Compounds Corporation, Carlstadt, N.J.
PC-3—commercial purging composition containing a proprietary mixture of inert minerals, inorganic salts, organic salts and thermoplastic polyolefins, available as RapidPurge® PM-5540 from Rapidurge, Stratford, Conn.
PVC—stabilized polyvinyl chloride BL235573, available from CCC Plastics, Colborne, Ontario, Canada)
Fiberglass: sized grade 408A, nominal diameter 13.7μ, chop length 4.0 mm., available from Owens Corning.
Sorbitol—available from Aldrich Chemical Company, Milwaukee, Wis.
Calcium Carbonate—Albagloss, available from Specialty Minerals, Inc., Bethlehem, Pa.
TECO SIL 44CSS Fused Silica, an electrically fused silica available from C-E Minerals, King of Prussia, Pa.
Zinc Stearate—available from Chemtura, Middlebury, Conn.
Calcium Stearate—available from Chemtura, Middlebury, Conn.
Irgafos® 168 antioxidant available from Ciba (BASF), Tarrytown N.Y.
Irganox® 1010 antioxidant, available from Ciba (BASF), Tarrytown N.Y.
Diglycerol—available from Solvay Chemical, Houston, Tex.

### Test Methods

### Moisture

Moisture was determined using a Mettler HB43 moisture analyzer from Mettler-Toledo, Inc., Columbus, Ohio at conditions of 130° C./30 minutes.

### Thermal Stability

Thermal stability was measured by thermogravimetric analysis coupled with infrared analysis (TGA-IR) of volatiles from the sample. A weighed portion of sample was positioned in the heating zone of a TA Instruments (New Castle, Del.) Q500 TGA instrument and heated from room temperature to the final temperature at a rate of 10° C./minute, then held at the final temperature for 20 minutes. The glass lined furnace was sealed under a purge gas of air at a constant flow rate. The sample was heated to a selected temperature at a programmed rate and the evolved gases were swept through a 20 cm infrared gas cell that was scanned continuously by the Nicolet FTIR spectrometer (Thermo Fisher Scientific Inc., Waltham, Mass.).

TABLE 1
Gases Evolved from TGA-IR Temperature Analyses

| | | | | Total |
|---|---|---|---|---|
| | | | 260° C., hold | Weight |
| | 100-200° C. | 200-260° C. | 20 min. | Loss |
| TPS-1 | H₂O, CO₂ | H₂O, CO₂, VOCs | H₂O, CO₂, VOCs | 28.8% |
| TPS-3 | H₂O, CO₂ | H₂O, CO₂, VOCs | H₂O, CO₂, VOCs | 29.8% |
| IS-1 | H₂O | H₂O | H₂O, CO₂, VOCs | 17.2% |

Volatile organic compounds (VOCs) positively identified included carbon monoxide, formaldehyde, formic acid, as well as non-specific alcohol-containing species.

### Preparation of TPS-4, TPS-5 and TPS-6

Blends having compositions summarized in Table 2 were extruded through a Werner and Pfleiderer (Ramsey, N.J.) ZSK-30 co-rotating twin screw extruder with 13 barrels and 12 heated zones equipped with a high work screw having elements as described in Table 3 and operated at 200 rpm with temperature settings of 50° C. in barrels 2-4, 90° C. in barrels 5-6, 120° C. in barrel 7, 180° C. in barrels 8-9, 170° C. or 180° C. in barrel 10, and 165° C. or 180° C. in barrels 11-13.

TABLE 2

| | TPS-4 | TPS-5 | TPS-6 |
|---|---|---|---|
| Component | (wt. %) | (wt. %) | (wt. %) |
| S-1 | 52.40% | 0.00% | 44.09% |
| S-2 | 0.00% | 55.85% | 0.00% |
| Water | 23.66% | 22.33% | 19.47% |
| Sorbitol | 4.20% | 4.57% | 6.79% |
| Calcium Carbonate | 2.10% | 2.28% | 3.40% |
| Zinc Stearate | 1.05% | 1.14% | 1.46% |
| Calcium Stearate | 1.05% | 1.14% | 1.46% |
| 67:33 Irgafos ®168 and | 0.08% | 0.09% | 0.07% |
| Irganox ® 1010 | | | |
| TECO SIL 44CSS Fused Silica | 0.00% | 0.00% | 10.67% |
| Diglycerol | 15.45% | 12.60% | 12.60% |
| Total | 100.00% | 100.00% | 100.00% |

Extrudates were collected, dried overnight at room temperature with nitrogen, then ground to pass through a 3/16-inch screen.

TABLE 3
Screw Attributes*

| Barrel | Screw Zone | Description |
|---|---|---|
| 1-2 | CZ1 | Conveying Zone 1 |
| 3 | KZ1 | Kneading Zone 1 |
| 4 | R1 | Reverse 1 |
| 5-6 | CZ2 | Conveying Zone 2 |
| 7 | KZ2 | Kneading Zone 2 |
| 8-10 | CZ3 | Conveying Zone 3 |
| 11 | KZ3 | Kneading Zone 3 |
| 11 | R2 | Reverse 2 |
| 12-13 | CZ4 | Conveying Zone 4 |

*Zones May Also Comprise Conveying Elements.

### Examples 1-16 and Comparative Examples C1-C6

General Purging Procedure 1: This procedure was used to assess the purging capability of various purging compositions in removing residual polymers from a twin screw extruder. The procedure employed the extruder and screw design described above. Temperature of Barrel 1 was controlled with cold water cooling and the barrel temperature settings were 50° C. in barrel 2, 120° C. in barrel 3, and 180° C. for barrels 4-13. No die was attached.

The screws were set to rotate at 200 rpm and a thermoplastic resin was fed at a rate of 20 lb/hr for 10 minutes to coat the inside of the extruder with a sticky residual resin that would adhere to the extruder interior surface and screw flights to simulate the end of a production processing run using the thermoplastic resin. The feed of residual resin was discontinued and the extruder screw speed was maintained at 200 rpm for 3 minutes. A purging composition was then fed to the extruder for 5 minutes at the screw speeds, feed rates, and barrel temperatures summarized in Table 4. Except where noted, a continuous polymer melt was observed exiting the extruders. The feed of purge composition was stopped and the extruder was operated at 200 rpm for 3 minutes. The screw speed was then reduced to zero and the screws were removed from the extruder barrel. The amount of material adhered to the screws was visually assessed and the ease of removal through use of a hand brush with stiff metal bristles was determined in one small section of the screw. The screws were then cleaned with a rotating power tool tipped with a stiff metal brush and the time to clean the screws was recorded. Finally, the appearance of the screw was visually assessed. The purge conditions, effort to remove the screw and the time to powerbrush the screw are summarized in Table 4. Visual observations of the screw and barrel prior to cleaning are reported in Table 5, and after cleaning in Table 6.

TABLE 4
Purging of 30 mm Twin Screw Extruder

| | | | Purge Conditions | | | Effort to | Time To |
|---|---|---|---|---|---|---|---|
| | | | | Feed | Barrel | Remove | Powerbrush |
| | | | | Rate | Temp. | Screw After | Screw |
| Example | Residual Resin | Purging Composition | RPM | (PPH) | (° C.) | Purging | (minutes) |
| C1 | Ionomer-1 | PC-1 | 200 | 10 | 180 | Easy | 25 |
| C2 | Ionomer-1 | PC-2 | 200 | 10 | 180 | Difficult | 35 |
| C3 | Ionomer-1 | PC-3 | 200 | 10 | 180 | Difficult | 24 |
| 1 | Ionomer-1 | TPS-1 (6.63% H2O) | 200 | 10 | 180 | Easy | 24 |
| 2 | Ionomer-1 | TPS-1 (1.38% H2O) | 200 | 10 | 180 | Easy | 20 |
| 3 | Ionomer-1 | TPS-3 (6.5% H2O) | 200 | 10 | 180 | Easy | 22 |
| 4 | Ionomer-1 | TPS-3 (1.27% H2O) | 200 | 10 | 180 | Easy | 14 |
| 5 | Ionomer-1 | (1) EMA-1, then | 200 | 10 | 180 | Easy | 9 |
| | | (2) TPS-3 (1.27% H2O) | | | | | |
| 6 | Ionomer-1 | TPS-3 (6.5% H2O) | 75 | 30 | 180 | Easy | 11 |
| 7 | POM-1 | TPS-3 (6.5% H2O) | 75 | 30 | 170 | Easy | 4 |
| 8 | LDPE | TPS-3 (1.27% H2O) | 75 | 30 | 180 | Difficult | 4 |
| C4 | Ionomer-1 | IS-1 (5.33% H2O) | 125 | 30 | 180 | Easy | 19 |
| C5 | Ionomer-1 | IS-1 (16.21% H2O) | 75 | 28 | 180 | Easy | 12 |
| 9 | Ionomer-1 | 90:10 IS-1 (16.21% | 75 | 30 | 180 | Moderate | 13 |
| | | H2O)/Sorbitol | | | | | |
| 10 | LDPE-1 | TPS-2 (3.55% H2O) | 75 | 30 | 180 | Moderate | 4 |
| 11 | LDPE-1 | 80:20 TPS-2 (3.55% | 75 | 30 | 180 | Moderate | 4 |
| | | H2O)/EMA-1 | | | | | |
| 12 | PA-6 | TPS-3 (7.22% H2O) | 75 | 30 | 230 | Easy | 0 |
| 13 | Ionomer-1 | TPS-4 (2.24% H2O) | 200 | 10 | 180 | Moderate | 15 |
| 14 | Ionomer-1 | TPS-5 (2.05% H2O) | 200 | 10 | 180 | Moderate | 13 |
| 15 | Ionomer-1 | TPS-6 (2.12% H2O) | 200 | 10 | 180 | Moderate | 17 |
| C6 | Ionomer-1 | 60:40 TPS-3 (6.5% | 200 | 10 | 180 | Moderate | >30(a) |
| | | H2O)/EVA-1 | | | | | |
| 16 | Ionomer-1 | 1) PC-3, then | 200 | 10 | 180 | Moderate | 14 |
| | | 2) TPS-3 (6.5% H2O) | | | | | |

(a)based on appearance

TABLE 5
Visual Observation of Polymer Residue on Screw and Extruder Barrel After Purging

| | Barrel | CZ1 | KZ1 | R1 | CZ2 | KZ2 | CZ3 | | KZ3 | R2 | CZ4 | |
|---|---|---|---|---|---|---|---|---|---|---|---|---|
| C1 | clean | clean | clean | 100% (c) | 100% (c) | 100% (c) | 100% | (c) | 100% (c) | 100% (c) | 100% | (c) |
| C2 | large (a) | clean | clean | 100% (c) | 100% (c) | 100% (c) | 100% | (c) | 100% (c) | 100% (c) | 100% | (c) |
| C3 | small (a) | 50% (c) | 50% (c) | 50% (c) | 50% (c) | 50% (c) | 50% | (c) | 50% (c) | 50% (c) | 50% | (c) |
| 1 | small (b) | clean | clean | clean | 50% (c) | clean | 50% | (c) | clean | clean | 25% | (c) |
| 2 | clean | clean | clean | clean | 10% (c) | clean | 10% | (c) | clean | clean | 10% | (c) |
| 3 | small (b) | clean | 25% (c) | clean | 10% (c) | 10% (c) | 10% | (c) | clean | clean | 10% | (c) |
| 4 | small (b) | clean | clean | clean | 10% (c) | 10% (c) | 10% | (c) | clean | clean | 10% | (c) |
| 5 | clean | clean | clean | clean | 10% (c) | 5% (c) | 5% | (c) | clean | clean | <5% | (c) |
| 6 | small (b) | clean | clean | clean | 5% (c) | clean | <5% | (c) | clean | clean | <5% | (c) |
| 7 | clean | clean | clean | clean | clean | clean | <5% | (c) | clean | clean | <5% | (c) |
| 8 | clean | clean | (d) | (d) | 10% (c) | 5% (c) | 10% | (c) | (d) | (d) | 50% | (c) |
| C4 | clean | clean | (e) | 75% (c) | 100% (c) | (e) | 100% | (c) | (e) | (e) | 100% | (c) |
| C5 | clean | clean | (e) | (e) | 100% (c) | (e) | 100% | (c) | (e) | (e) | 100% | (c) |
| 9 | clean | clean | 100% (c) | (e) | 50% (c) | 50% (c) | 50% | (c) | clean | clean | 50% | (c) |
| 10 | clean | clean | (d) | (d) | 5% (c) | clean | 10% | (c) | clean | clean | 25% | (c) |
| 11 | clean | clean | (d) | (d) | clean | clean | 25% | (c, f) | clean | clean | 25% | (c, f) |
| 12 | clean | (d) | (d) | clean | clean | clean | clean | | clean | clean | clean | |
| 13 | clean | 10% (c) | (d) | (d) | 25% (c) | 30% (c) | 10% | (c) | (d) | (d) | 25% | (c) |
| 14 | clean | 10% (c) | (d) | (d) | clean | (d) | 5% | (c) | (d) | (d) | 10% | (c) |
| 15 | clean | 10% (c) | (d) | (d) | 50% (c) | 25% (c) | 20% | (c) | 10% (c) | 10% (c) | 20% | (c) |
| C6 | — | — | — | — | — | — | — | | — | — | 100% | |
| 16 | clean | 75% (c) | (d) | (d) | 75% (c) | 25% (c) | 10% | (c) | 10% (c) | 10% (c) | 20% | (c) |

(a) polymer adhered to barrel, removable with brush
(b) loose polymer that was not stuck to barrel and was removable with only compressed air
(c) percentage of screw surface covered with polymer residue
(d) polymer wrapped around elements, but readily peeled off in less than 30 seconds
(e) polymer powder compacted around elements, but readily removed by hand with a stiff wire brush in less than 30 seconds
(f) stickier residue than Example 10, more difficult to clean the elements

TABLE 6
Visual Observation of Purged, Then Brushed Screw

| Screw Zone | CZ1 | KZ1 | R1 | CZ2 | KZ2 | CZ3 | KZ3 | R2 | CZ4 |
|---|---|---|---|---|---|---|---|---|---|
| Screw | S | DB | DB | DB | DB | DB | DB | DB | DB |
| Appearance | | | | | | | | | |
| Prior to | | | | | | | | | |
| Study | | | | | | | | | |
| C1 | S | DB | DB | DB | DB | DB | DB | DB | DB |
| C2 | S | DB | DB | DB | DB | DB | DB | DB | DB |
| C3 | S | DB | DB | DB | DB | DB | DB | DB | DB |
| 1 | S | LB | LB | LB | LB | LB | LB | LB | DB |
| 2 | S | LB | LB | LB | LB | LB | LB | LB | DB |
| 3 | S | LB | LB | LB | LB | LB | LB | LB | DB |
| 4 | S | LB | LB | LB | LB | LB | LB | LB | DB |
| 5 | S | LB | LB | LB | LB | LB | LB | LB | DB |
| 6 | S | LB | LB | LB | LB | LB | LB | LB | DB |
| 7 | S | LB | LB | LB | LB | LB | LB | LB | DB |

“S” = shiny
“DB” = dull black
“LB = light black

The comparative purging materials utilized in Comparative Examples C1-C3 adhered to the screws and required significant powerbrushing to remove, which is particularly difficult in closely-spaced or intricate sections of the screw such as the teeth of kneading elements. The purging materials utilized in the Examples were particularly effective at cleaning the kneading elements. The visual appearance of the screws was significantly improved after the purging operation was complete in the Examples vs. the appearance of the screws after the purging operation described for Comparative Examples C1-C3.

The lower moisture content of Examples 2 and 4 compared to Examples 1 and 3, respectively, provided higher melt viscosity of the purging composition. Without being bound by theory, the higher melt viscosity may have improved purging effectiveness.

The results shown for Example 5 compared to those of Example 4 indicate that intermediate purging with a polar ethylene copolymer can improve purging performance.

The higher purge feed rate and slower screw speed utilized in Example 6 compared to the comparable conditions used in Example 3 acted to fill the extruder barrel to a greater extent, which resulted in better purge performance.

Comparative Examples C4 and C5 indicated that an industrial starch without plasticizer, when used as a purge composition, was ground by the extrusion process. Powder was observed exiting the barrel. In Example 9, the extrudate exited the barrel as a continuous melt. Mixing elements in zones KZ1 and KZ2 had some amount of Ionomer-1 polymer residue, which may be due to the fact that the starch and plasticizer were mixing in these zones. Zone KZ3 was scrubbed clean, which indicates mixing was complete when the purging composition reached this section of the barrel and the continuous polymer melt cleaned these elements. When the TPS-5 material was compounded on the extruder, the screw was removed and examined. The Zone CZ1, KZ1, and R1 elements had some amount of residue that was more difficult to remove than the residue in the subsequent screw sections. Subsequent use of the compounded material for purging in ex. 14 showed little residue on the Zone CZ1, KZ1, and R1 elements.

In Example 11, the residue on the screw was noticeably stickier than in Example 10, wherein the purge composition contained no EMA-1, and it was more difficult to clean the elements. In Example 12, time to powerbrush the screw of 0 minutes is reported in Table 4 because the screw was judged clean.

### Example 17

A W&P ZSK-30 twin screw extruder with L/D 29.3 and 9 heated barrels was utilized. The screw had a first conveying zone that spanned barrels 1-2, a kneading zone in barrel 3, a conveying zone in barrel 4, intensive kneading and gear mixing elements zone in barrels 5-6, and conveying elements in barrels 7-9. A temperature profile of 280-240° C. was used to extrude PET-1. An intermediate purge was fed at 10 lb/hr for 5 minutes which consisted of a composition with a 20:37:43 wt. ratio of Fiberglass OCF408A/H₂O/HDPE-1. This was fed while simultaneously reducing barrel temperatures to 190° C. The die was also removed after the intermediate purge was complete. When the barrel temperatures reached 190° C., TPS-3 with a moisture content of 6.5% was used to purge at a rate of 12 lb/hr and 100 rpm screw speed for 10 minutes. The screw was then pulled and inspected. The first conveying and kneading zones had no polymer residue. The intensive kneading and gear mixing elements in barrels 5-6 had TPS-3 resin wrapped around the mixing elements, but the resin did not adhere to the metal and was readily peeled by a gloved hand and the underlying mixing elements were clean. The conveying elements in barrels 7-9 were 50% covered with polymer residue. This Example illustrates a process wherein purging of a high temperature resin is accomplished by purging with a fiberglass-filled polyethylene agent with a melt temperature of less than 200° C., reducing the barrel temperatures to less than 200° C., then purging with a starch purge agent.

### Comparative Example C7

A Werner and Pfleiderer (Ramsey, N.J.) 40 mm co-rotating twin screw extruder with 10 barrels and heated zones was equipped with a medium work screw that had elements for melting, mixing and conveying polymer. The barrel temperatures were set to 150° C. in barrel 1, 160° C. in barrel 2, and 170° C. for barrels 3-10 and die. Cellulose acetate butyrate CAB-531-1 was extruded through the equipment. This coated the inside of the extruder with this polymer. The die was removed and the extruder screws were rotated until extrudate was no longer observed. The extruder was purged with HDPE-2 for 4 hours at 50 lb/hr. Subsequent removal of the screws resulted in generation of a very strong unpleasant odor, indicating ester hydrolysis of the cellulose acetate butyrate was occurring. Purging of the extruder was similarly carried out with PC-3 and generation of a strong odor again occurred.

### Example 18

The procedure of Comparative Example C7 was generally repeated, but the purging procedure was conducted by utilizing first 25 lb of TPS-3 (5-8% moisture), then 20 lb of TPS-1 (5-8% moisture), then 9 lb of TPS-3 (5-8% moisture). The purge feed rate was varied from 50-75 lb/hr. At the end of the procedure the screw was removed from the extruder barrel. Only a faint unpleasant odor was sensed in the direct vicinity of the extruder barrels and screw. The screws were judged clean and did not require powerbrushing.

### Example 19

A Werner and Pfleiderer (Ramsey, N.J.) ZSK-30 co-rotating twin screw extruder with 13 barrels and 12 heated zones was equipped with a high work screw that had screw elements that functioned to convey material in barrels 1-2, mix material in barrel 3, convey material in barrels 4-5, mix material in barrels 6-7, convey material in barrels 8-9, mix material in barrels 10-11, and convey material in barrels 12-13. The barrel temperature settings were 70° C. for barrel 2, 120° C. for barrel 3, 150° C. for barrel 4 and 180° C. for barrels 5-13. A die adapter and die with a 3/16-inch hole were attached to the extruder, and heated to 180° C. The screw speeds were set to 200 rpm and EMAA-1 was fed at a rate of 20 lb/hr for 10 minutes to coat the inside of the extruder with polymer. The extruder screws were turned to empty the barrel, then TPS-3 (5-8% moisture) was fed at 8 lb/hr with a screw speed of 75 rpm for 10 minutes. The extruder screws were rotated to empty the barrel, and the die and die adapter were then removed. The die had a frozen plug of purge composition that did not adhere and was readily pushed out with a small pointed tool and left no residue on the die. The die adapter similarly had a plug of frozen purge resin that was easily removed and no residue remained on the metal. The screw removal was difficult. The screw conveying elements nearest the die were 25% covered with polymer residue, the adjacent mixing elements were clean, the next conveying elements were 50% covered with polymer residue, the next mixing elements were 5% covered with polymer residue, the next conveying elements were 10% covered with polymer residue, and the next mixing and conveying zones had loose strips of purge polymer that did not adhere and were removed by hand. The screw elements were easily removed from the screw shaft and were burned clean. The powerbrushing time for cleaning the polymer residue on this screw was estimated to have required 5 minutes.

### Example 20

A Coperion Werner and Pfleiderer (Ramsey, N.J.) ZSK-26 co-rotating twin screw extruder with 14 barrels and 13 heated zones was equipped with a medium work screw that had screw elements that functioned to convey material in barrels 1-8, mix material in barrels 9-12, and convey material in barrels 13-14. The barrel temperature settings were 100° C. in barrel 1, 195° C. in barrel 2, and 250° C. for barrels 3-13. A die with four 3/16-inch holes was attached, and heated to 250° C. Vacuum was applied at barrel 13. The screw speeds were set to 100 rpm and a mixture of TPEs with peak melting points from 148-203° C. were fed to the extruder to coat the inside of the extruder. The extruder screws were rotated to empty the barrel, then TPS-3 (5-8% moisture) was fed at 10 lb/hr with a screw speed of 50 rpm for 15 minutes. The extruder screws were rotated to empty the barrel, and the die was removed and judged to be clean. The screws were removed and were judged to be 25% covered with polymer residue on all elements. The elements were readily removed by hand, then further cleaned in a burnout oven.

Examples 19 and 20 demonstrate purging an extruder equipped with a die. The die is believed to provide significant backpressure to the system, which resulted in better cleaning of screw elements near the die compared to cleaning the extruder without a die.

### Comparative Examples C8-C10 and Examples 21-23

The following Comparative Examples C8-C10 and Examples 21-23 illustrate purging an injection molding machine. A Nissei Injection Molding Machine FN4000, equipped with a 0.35-inch diameter nozzle tip, was used (available from Nissei Plastic Industrial Co., Ltd., 2110, Minamijo, Sakaki-machi, Hanishina-gun, Nagano-ken 389-06, Japan). The machine was operated at 97 rpm with 2 MPa back pressure. A black resin, prepared from a 95:5 by weight pellet blend of a first resin and black masterbatch BMB-1 was used to fill the barrel of the machine (for Comparative Example C8, the machine was filled with black resin at 67 rpm). The resins used in the Comparative Examples C8-C10 were then transitioned without a transitional purge step to a second colorless resin and material (“purge plops”) were collected until the second resin extrudate was judged colorless. For Comparative Example C8 and C9, the second resin was still light grey when the runs were stopped. For Examples 21-23, a transitional purge step was conducted using a starch purge composition and then the second colorless resin was run through the equipment until the purge plops were judged colorless. The results are summarized in Table 7. These Examples demonstrate that transition between resins on an injection molding machine can be accomplished in less time and with less total quantity of resin when a transitional purge with a starch composition is used.

TABLE 7
Purging of Injection Molding Machine

| Example | C8 | | 21 | | C9 | | 22 | | C10 | | 23 | |
|---|---|---|---|---|---|---|---|---|---|---|---|---|
| Rear Barrel Temperature(° C.) | 220 | | 220 | | 150 | | 150 | | 150 | | 150 | |
| Middle Barrel Temperature(° C.) | 225 | | 225 | | 200 | | 200 | | 200 | | 200 | |
| Front Barrel Temperature(° C.) | 245 | (a) | 245 | (a) | 200 | | 200 | | 200 | | 200 | |
| Nozzle Temperature (° C.) | 245 | (a) | 245 | (a) | 200 | | 200 | | 200 | | 200 | |
| First Black Resin | PA-6 | | PA-6 | | PP-1 | | PP-1 | | Ionomer-2 | | Ionomer-2 | |
| (95% Resin + 5% BMB-1) | | | | | | | | | | | | |
| Transitional Purge Step | | | | | | | | | | | | |
| Purge Composition (b) | None | | TPS-3 (1.79% water) | | None | | TPS-3 (1.79% water) | | None | | TPS-3 (7.1% water) | |
| Number of Purge Plops | — | | 6 | | — | | 6 | | — | | 9 | |
| Weight of Purge fed to hopper | — | | 2.0 | Kg | — | | 2.0 | Kg | — | | 3.0 | Kg |
| time to purge | — | | 5.5 | min. | — | | 5.5 | min. | — | | 8.0 | min. |
| Second Colorless Resin (virgin) | PP-1 | | PP-1 | | Ionomer-2 | | Ionomer-2 | | PP-1 | | PP-1 | |
| Number of Purge Plops to Colorless | >32 | (b) | 8 | | >47 | (b) | 13 | | 38 | | 9 | |
| Wt. of Purge plops collected | >5.7 | Kg | 1.4 | Kg | >7.4 | Kg | 2.0 | Kg | 6.4 | Kg | 1.5 | Kg |
| time to purge | >25 | min. | 7.3 | min. | >30 | min. | 8.5 | min. | 30 | min. | 8.5 | min. |
| Total Purge Plops | >32 | (b) | 14 | | >47 | (b) | 19 | | 38 | | 18 | |
| Total Purge Weight | >5.7 | Kg | 3.4 | Kg | >7.4 | Kg | 4 | Kg | 6.4 | Kg | 4.5 | Kg |
| Total Purge Time | >25 | min. | 8.9 | min. | >30 | min. | 14 | min. | 30 | min. | 16.5 | min. |

(a) this temperature requires good local ventilation due to evolution of volatile organic chemical (formaldehyde)
(b) still a grey hue when purging discontinued

### Example 24

A Berstorff (Florence, Ky., U.S.A.) ZE-25 25 mM co-rotating twin screw extruder with 10 barrels and L/D of 50:1 and a satellite single-screw extruder to feed elastomer was equipped with a high work screw that had screw elements that functioned to convey material in barrels 1-3, mix material between barrels 3-4, convey material in barrel 4, mix material in barrels 5-8 and convey material in barrels 9-10. The barrel temperature settings were 100° C. in barrel 2 and 130° C. in barrels 3-10. A die adapter and 4-hole die with ⅛-inch holes were attached to the extruder, and heated to 130° C. The screw speeds were set at 200 rpm and an amorphous elastomeric copolymer of ethylene and 62 wt % methyl acrylate with a melt flow rate of 15 g/10 minutes (190° C., 2.16 kg), available from DuPont, (EMA-2) was fed at a rate of 6 lb/hr for 15 minutes into barrel 2. This coated the inside of the extruder with sticky elastomer. A melt temperature of 160° C. was measured at the exit of the die. The extruder screws were rotated to empty the barrel, then TPS-3 (5.81% moisture) pellets were fed at 20 lb/hr via a loss-in-weight feeder to barrel 1 with a screw speed of 200 rpm for 3 minutes. The die was then removed and the purge residue did not adhere and was readily removed. No elastomer residue was noted on the die. The purge agent was then fed at 75 rpm for 5 minutes. A melt temperature of 139° C. was measured at the end of the barrel. The screw removal was difficult. The screw conveying elements in barrels 1-3 were 15% covered with elastomer residue, the adjacent mixing elements were clean, the next conveying elements were 25% covered with elastomer residue, the next mixing elements had purge composition wrapped around the screw that did not adhere and was readily removed by hand, and the final conveying zone was clean. The screw elements were easily removed from the screw shaft and were burned clean. The powerbrushing time to clean the polymer residue on this screw was estimated to be 5 minutes.

### Example 25

This Example demonstrates purging PVC from an extruder equipped with a die. A Coperion Werner & Pfleiderer (Stuttgart, Germany) twin screw extruder with 7 heated zones was equipped with a low work screw that had approximately 45 screw elements. Screw elements 1-8 functioned to convey material, elements 9-13 mixed material, elements 14-35 conveyed material, elements 36-39 mixed material, and elements 40-45 conveyed material to the die. The barrel temperature settings were adjusted to profile the temperature from 180° C. to 190° C. at the die. A 2-hole die with ⅛-inch holes was attached. The screw speeds were set to 150 rpm and stabilized PVC formulation BL 235573 (CCC Plastics, Colborne, Ontario Canada), was fed at a rate of 13 lb/hr, which coated the inside of the extruder with PVC. The extruder screws were rotated to empty the barrel, TPS-3 (5.81% moisture) pellets were fed at 10 lb/hr with a screw speed of 150 rpm until purge resin began to pass through the die and die pressure reached 70 bar. The purge feed was stopped and the die was then removed. The purge residue did not adhere to the die and was readily removed. The purge agent feed was resumed at 15 lb/hr and 150 rpm for 5 minutes. The purge feed was discontinued and the screws were rotated until extrudate stopped. The screw removal was easy. Screw elements 1-8 were 25% covered with PVC residue, 9-13 were wrapped with purge composition that was easily removed by hand to afford clean elements underneath, and the remaining screw elements were clean. The screw elements were easily removed from the screw shaft and were burned clean.

1. A method for cleaning the interior of polymer processing equipment having a resin composition retained in the interior thereof, the resin composition comprising a polymer selected from the group consisting of thermoplastic resins, thermoplastic elastomers and uncrosslinked elastomers wherein the resin composition comprises less than 20 weight percent starch, and wherein a contaminant material is adhered to at least a portion of the interior surface of the polymer processing equipment, the method comprising the steps of:
(A) charging the polymer processing equipment having a resin composition retained in the interior thereof with a purging composition comprising
(1) 45-94 weight % of starch;
(2) 0.05 to 20 weight % of water; and
(3) 5 to 45 weight % of polyol plasticizer,
wherein the weight percentages of starch, water and polyol plasticizer are based on the total weight of starch, water and polyol plasticizer;
(B) operating the polymer processing equipment to i) convey the purging composition through the polymer processing equipment, thereby removing and withdrawing substantially all of the resin composition from the polymer processing equipment and causing a portion of the purging composition to be retained as a residual purging composition within the interior of the polymer processing equipment; and ii) remove at least a portion of the contaminant material that is adhered to at least a portion of an interior surface of the polymer processing equipment; and
(C) removing the portion of the purging composition retained as a residual purging composition from within the interior of the polymer processing equipment.

2. A method of claim 1 wherein removing the portion of the purging composition retained as a residual purging composition from within the interior of the polymer processing equipment comprises
A. charging the polymer processing equipment having a portion of the purging composition retained as a residual purging composition within the interior of the polymer processing equipment with a fresh polymer composition selected from the group consisting of thermoplastic resin compositions, thermoplastic elastomer compositions and uncrosslinked elastomer compositions; and
B. operating the polymer processing equipment to convey the fresh polymer composition through the polymer processing equipment, thereby removing and withdrawing substantially all of the purging composition from the polymer processing equipment.

3. The method of claim 1 wherein removing the portion of the purging composition retained as a residual purging composition from within the interior of the polymer processing equipment comprises disassembling the polymer processing equipment and physically cleaning the interior of the polymer processing equipment.

4. A method of claim 1 wherein the resin composition that is retained in the interior of the processing equipment prior to charging the equipment with a purging composition comprises a polymer selected from the group consisting of polyethylene, polypropylene, ethylene copolymers comprising a polar comonomer, polyester, copolyester, copolyesterether, copolyetheramides, polyvinyl chloride, poly(hydroxyalkanoic acids), polyoxymethylene, polyamide, polycarbonate, polystyrene, polyurethanes, urethanes, and cellulose and ether and ester derivatives thereof.

5. A method of claim 1 wherein the purging composition further comprises from 2 to 15 parts of a water soluble polymer; based on 100 parts of the purge composition.

6. A method of claim 5 wherein the water soluble polymer is selected from the group consisting of polyvinyl alcohol, copolymers of ethylene and vinyl alcohol and combinations of two or more thereof.

7. A method of claim 1 wherein the purging composition further comprises from 2 to 50 parts of filler, based on 100 parts of the purge composition.

8. A method of claim 7 wherein the filler is selected from the group consisting of silica, wollastonite or a combination thereof.

9. A method of claim 1 wherein the starch is an unmodified starch.

10. A method of claim 1 wherein the starch is other than hydroxypropylated high amylose starch.

11. A method of claim 1 wherein the purging composition further comprises up to 20 parts by weight per 100 parts purging composition of a substantially water-insoluble resin.

12. A process for reducing defects in shaped resin articles that are formed in polymer processing equipment, the process comprising the steps of
A) charging a first resin to polymer processing equipment, the resin comprising a polymer selected from the group consisting of thermoplastic resins, thermoplastic elastomers and uncrosslinked elastomers wherein the resin comprises less than 20 weight percent starch and conveying said first resin through the polymer processing equipment to form a stream of the first resin under conditions such that a portion of said first resin is retained in the equipment;
B) forming one or more shaped articles comprising the first resin from the stream of the first resin;
C) cleaning the interior of the polymer processing equipment having a portion of said first resin retained therein by charging the polymer processing equipment with a purging composition, the purging composition comprising
1) 45-94 weight percent starch;
2) 0.05 to 20 weight percent water; and
3) 5 to 45 weight percent polyol plasticizer;
wherein the weight percentages of starch, water and polyol plasticizer are based on the total weight of starch, water and polyol plasticizer present in the purging composition;
D) operating the polymer processing equipment at a temperature below the decomposition temperature of the starch to convey the purging composition through the polymer processing equipment, thereby removing and withdrawing substantially all of the first resin from the polymer processing equipment;
E) charging a second resin to the polymer processing equipment, the resin being different from the first resin and comprising a polymer selected from the group consisting of thermoplastic resins, thermoplastic elastomers and uncrosslinked elastomers wherein the resin comprises less than 20 weight percent starch and conveying said second resin through the polymer processing equipment; and
F) forming one or more shaped articles of the second resin,
whereby the one or more shaped articles of the second resin that are produced are substantially free of defects.
